(19) United States
(12) Patent Application Publication
(10) Pub. No.: US 2025/0240698 A1
(43) Pub. Date: Jul. 24, 2025

(54) REFLECTIVE DIFFERENTIATED SERVICES CODE POINT

(71) Applicant: Telefonaktiebolaget LM Ericsson (publ), Stockholm (SE)

(72) Inventors: Robert SKOG, Hässelby (SE); Jan BACKMAN, Kärna (SE)

(73) Assignee: Telefonaktiebolaget LM Ericsson (publ), Stockholm (SE)

(21) Appl. No.: 18/833,399

(22) PCT Filed: Feb. 28, 2022
(86) PCT No.: PCT/EP2022/055010

§ 371 Date: Jul. 26, 2024

(51) Int. Cl. H04W 40/12; H04W 28/02; H04W 48/18

(52) U.S. Cl. CPC H04W 40/12; H04W 28/0268; H04W 48/18

(57) ABSTRACT

A method for marking a Quality of Service (QOS) for packet traffic on a connection between a User Equipment (UE) and a destination device. The method provides for receiving, from the UE, an Uplink (UL) carrier traffic destined for the destination device, the UL carrier traffic including a QoS parameter to indicate a class of QoS applied to the UL carrier traffic, associating the QoS parameter with routing information carried in the UL carrier traffic and storing the QoS parameter linked to the routing information in a data structure. The method further provides for receiving Downlink (DL) carrier traffic from the destination device, wherein the DL carrier traffic includes the routing information, and associating the routing information carried in the DL carrier traffic with the routing information stored in the data structure to retrieve the QoS parameter to mark QoS for the DL carrier traffic.

### TECHNICAL FIELD

Embodiments of the disclosure relate to the field of communications; and more specifically, to the reflection of uplink Quality of Service parameter for use in downlink to designate Quality of Service for a downlink carrier traffic.

### BACKGROUND ART

The 3rd Generation Partnership Project (3GPP) unites a number of telecommunications standard developments, of which the 5th Generation (5G) communications technology is the newest. 5G communications systems employ a new 5G core (5GC) and new radio access technology referred to as New Radio (NR). One of the changes with the deployment of the 5G systems is to accommodate flow based Quality of Service (QOS), where packets are classified and marked using QoS Flow Identifier (QFI), instead of mapping between a system core (e.g., Evolved Packet Core (EPC)) and radio bearers, which was the practice with 4th Generation (4G) Long Term Evolution (LTE) communication systems. The 5G/NR system flows are mapped at the access network to radio bearers and multiple flows can exist.

QOS is the description or measurement of the overall performance of a service, such as telephony, computer network, or cloud computing, and the performance seen by the users of the network. To quantitatively measure QoS, several related aspects of the network service are often considered, such as packet loss, bit rate, throughput, transmission delay, availability, jitter, etc.

Furthermore, in 3GPP, the QoS concept as used in LTE/5G networks is class-based, where each carrier type is assigned one QoS Class Identifier (QCI) by the network. QCI is a mechanism used in LTE and 5G networks to ensure carrier traffic is allocated appropriate QoS. Different carrier traffic requires different QoS and therefore different QCI values. For example, QCI value 9 is typically used for default carrier.

Currently in LTE/5G communications systems, an assigned QoS in an uplink carrier traffic (e.g., from a user to a server via the communications network) does not necessarily guarantee that the returning carrier traffic from the server to the user maintains the same QoS. To ensure that QoS of carrier traffic in LTE/5G networks is appropriately handled, a mechanism is needed to classify the different types of carriers into different classes from a QoS perspective and retain the QoS information with the communication system in order to indicate the QoS for the returning carrier traffic.

### SUMMARY

Certain aspects of the present disclosure and their embodiments provide solutions to challenges noted above. In one aspect of the disclosed system, a method, at a node, provides for marking a Quality of Service (QOS) for packet traffic on a connection between a User Equipment (UE) and a destination device, wherein the node is disposed along the connection between the UE and the destination device. The method further provides for: receiving, from the UE, an Uplink (UL) carrier traffic destined for the destination device, the UL carrier traffic including a QoS parameter to indicate a class of QOS applied to the UL carrier traffic; in response to receiving the UL carrier traffic, associating the QoS parameter with routing information carried in the UL carrier traffic and storing the QoS parameter linked to the routing information in a data structure; in response to the destination device responding to the UL carrier traffic, receiving Downlink (DL) carrier traffic from the destination device, wherein the DL carrier traffic includes the routing information; and in response to receiving the DL carrier traffic, associating the routing information carried in the DL carrier traffic with the routing information stored in the data structure to retrieve the QoS parameter to mark QoS for the DL carrier traffic.

In another aspect of the disclosed system, the method further provides, in response to retrieving the QoS parameter from the data structure, applying the QoS parameter to set QoS for the DL carrier traffic.

In another aspect of the disclosed system, the QoS parameter is Differentiated Services Code Point (DSCP).

In another aspect of the disclosed system, the QoS parameter is QoS Flow Identifier (QFI).

In another aspect of the disclosed system, the data structure is associated with a User Plane Function (UPF) of a 5th Generation (5G) communications system.

In another aspect of the disclosed system, the data structure is associated with a packet gateway of a communications system.

In another aspect of the disclosed system, the data structure is a flow table.

In another aspect of the disclosed system, the routing information comprises a 5-tuple set which includes a source Internet Protocol (IP) address, source port number, destination IP address, destination port number, and a type of protocol being employed, wherein the QoS parameter is associated with the 5-tuple set and stored in the data structure linked to the 5-tuple set.

In another aspect of the disclosed system, the connection between the UE and the destination device utilizes a network slice of a plurality of network slice connections between the UE and one or more destination devices.

In another aspect of the disclosed system, a node provides for marking a QoS for packet traffic on a connection between a UE and a destination device, wherein the node is disposed along the connection between the UE and the destination device, the node configured to: receive, from the UE, an UL carrier traffic destined for the destination device, the UL carrier traffic including a QoS parameter to indicate a class of QoS applied to the UL carrier traffic; in response to receiving the UL carrier traffic, associate the QoS parameter with routing information carried in the UL carrier traffic and store the QoS parameter linked to the routing information in a data structure; in response to the destination device responding to the UL carrier traffic, receive DL carrier traffic from the destination device, wherein the DL carrier traffic includes the routing information; and in response to receiving the DL carrier traffic, associate the routing information carried in the DL carrier traffic with the routing information stored in the data structure to retrieve the QoS parameter to mark QoS for the DL carrier traffic.

In another aspect of the disclosed system, a computer program containing instructions which, when executed on at least one processor, cause the at least one processor to carry out a method that provides for marking a QoS for packet traffic on a connection between a UE and a destination device, wherein the node is disposed along the connection between the UE and the destination device. The computer program provides for receiving, from the UE, an UL carrier traffic destined for the destination device, the UL carrier traffic including a QoS parameter to indicate a class of QOS applied to the UL carrier traffic; in response to receiving the UL carrier traffic, associating the QoS parameter with routing information carried in the UL carrier traffic and storing the QoS parameter linked to the routing information in a data structure; in response to the destination device responding to the UL carrier traffic, receiving DL carrier traffic from the destination device, wherein the DL carrier traffic includes the routing information; and in response to receiving the DL carrier traffic, associating the routing information carried in the DL carrier traffic with the routing information stored in the data structure to retrieve the QoS parameter to mark QoS for the DL carrier traffic.

In another aspect of the disclosed system, a computer-readable storage medium has stored thereon a computer program which provides for carrying out a method for marking a QoS for packet traffic on a connection between a UE and a destination device, wherein the node is disposed along the connection between the UE and the destination device. The method further provides for receiving, from the UE, an UL carrier traffic destined for the destination device, the UL carrier traffic including a QoS parameter to indicate a class of QoS applied to the UL carrier traffic; in response to receiving the UL carrier traffic, associating the QoS parameter with routing information carried in the UL carrier traffic and storing the QoS parameter linked to the routing information in a data structure; in response to the destination device responding to the UL carrier traffic, receiving DL carrier traffic from the destination device, wherein the DL carrier traffic includes the routing information; and in response to receiving the DL carrier traffic, associating the routing information carried in the DL carrier traffic with the routing information stored in the data structure to retrieve the QoS parameter to mark QoS for the DL carrier traffic.

There are, proposed herein, various embodiments which address one or more of the issues disclosed herein. Certain embodiments may provide one or more of the following technical advantage(s).

A solution disclosed herein works with existing QoS concepts (e.g., DiffServ), but is expanded to let the communications service providers classify the downlink traffic in a simple manner. Thus, in one technique, DSCP used in the downlink is the same as in the uplink. That is, the uplink DSCP is “reflected” for use also as the downlink DSCP

A solution disclosed herein does not require any new 3GPP standardization and, therefore, faster to implement than alternative solutions.

A solution disclosed herein allows communications service providers to use data structures that already exist. For example, flow tables already exist within the 5G core system thereby simplifying the implementation.

A solution disclosed herein can be implemented within a communication core or external to the communication core.

A solution disclosed herein allows a DSCP value in UL to be stored in a flow table for use as a DSCP value in the downlink. An operator of the communications system can control whether to implement this technique or not to implement.

### BRIEF DESCRIPTION OF THE DRAWINGS

The embodiments of the disclosure may best be understood by referring to the following description and accompanying drawings. In the drawings:

FIG. 1 shows a 5G communications system as currently practiced in the industry;

FIG. 2 shows a 5G communications system in accordance with some embodiments of the present disclosure;

FIG. 3 shows a 5G communications system in accordance with some embodiments of the present disclosure;

FIG. 4 shows a table of DSCP values for use in accordance with some embodiments of the present disclosure;

FIG. 5 shows an example data structure linking the QoS parameter to the routing information in accordance with some embodiments of the present disclosure;

FIG. 6 shows a method for marking a QoS for packet traffic on a connection between a UE and a destination device in accordance with some embodiments of the present disclosure;

FIG. 7 shows a signalling diagram in which the UL carrier traffic and the DL carrier traffic utilize the flow table to store the UL DSCP value, in order to mark the DL carrier traffic with the same DSCP value, in accordance with some embodiments of the present disclosure;

FIG. 8 shows a use of a flow table in a packet gateway of a 4G LTE communications system in accordance with some embodiments of the present disclosure;

FIG. 9 illustrates an example of employing the disclosed technique, where the connection between the UE and the destination device utilizes a network slice of a plurality of network slice connections, in accordance with some embodiments of the present disclosure;

FIG. 10 illustrates an example of employing the disclosed technique where the connection that employs the data structure to store the QoS parameter is an Over the Top (OTT) connection in accordance with some embodiments of the present disclosure;

FIG. 11 shows an UPF node or Gateway node in accordance with some embodiments of the present disclosure; and

FIG. 12 shows an UPF node or Gateway node in accordance with some embodiments of the present disclosure.

### DETAILED DESCRIPTION

The following description describes methods and apparatus for reflective Differentiated Services Code Point (DSCP) in order to ensure application of correct QoS on a traffic carrier in both Uplink (UL) and Downlink (DL). However, the technique can be applied to other quality indicators, such as QoS Flow identifier (QFI). The following description describes numerous specific details such as operative steps, resource implementations, data structures, types of network functions, types of QoS indicators, and interrelationships of system components to provide a more thorough understanding of the present disclosure. It will be appreciated, however, by one skilled in the art that the embodiments of the present disclosure can be practiced without such specific details. In other instances, control structures, circuits, memory structures, system and/or network functions, and software instruction sequences have not been shown in detail in order not to obscure the present disclosure. Those of ordinary skill in the art, with the included descriptions, will be able to implement appropriate functionality without undue experimentation.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, model, or characteristic is described in connection with an embodiment, it is submitted that it is within the knowledge of one skilled in the art to implement such feature, structure, characteristic, or model in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in some embodiments of the present disclosure.

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some of the embodiments contemplated herein apply to specific functions, data structures, gateways, etc., associated with 5G communication technologies or 4G/LTE. Some embodiments can employ different functions, structures, gateways, etc. The disclosure describes the use of DSCP as an example, however, other parameters or indicators can be employed. Some embodiments may apply other QoS parameters and/or protocols.

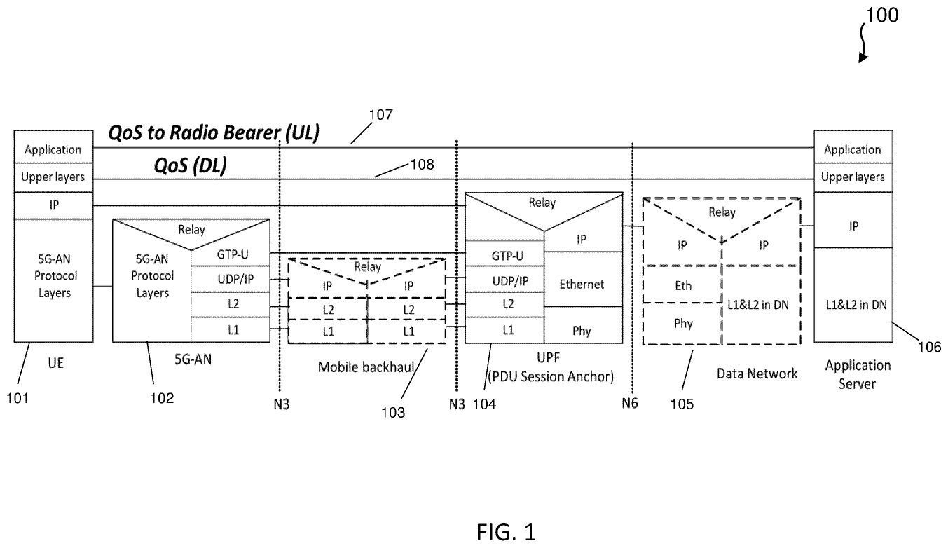

FIG. 1 shows a 5G communications system 100 as currently practiced in the industry. The system 100 includes a User Equipment (UE) 101, a 5G Access Network (5G-AN) 102, a Mobile Backhaul 103, a User Plane Function (UPF) 104, a Data Network (DN) 105, which connects to an Application Server (AS) 106. The UE 101 wirelessly connects to the 5G-AN 102 via a wireless interface. A variety of devices and/or user connections can be connected to 5G-AN 102. Such devices can be a variety of terminal devices, commonly referred to as UE. The devices can include, but are not limited to, computers, laptops, set-top boxes, televisions, mobile devices, wireless devices, machine type device, Internet of Things (IoT) devices, etc. These terminal devices provide services in the areas of data transfer, including Enhanced Mobile Broadband (eMBB), Machine Type Communications (MTC), Massive MTC (MMTC) and Ultra Reliable Low Latency Communications (URLLC), IoT, Massive IoT, and Critical IoT, as well as voice and streaming data.

The 5G-AN 102 connects to the UPF 104, which UPF 104 is part of the 5G Core (5GC) of the 5G communications system. The UPF 104 connects to the DN 105, such as the Internet. The DN 105 connects to an end device, shown as AS 106, which provides services requested by the UE 101 or by an application executing on UE 101.

In the example, the UE 101 communicates with the AS 106, via the various components shown, by initiating UL carrier traffic 107. The UE use QoS rules to set the QoS for the UL carrier traffic 107. For example, the UE can mark the UL packets for a carrier traffic flow using QFI.

For the carrier traffic being sent from the AS 106 to the UE in the DL direction, in response to the UL carrier traffic, the UPF 104 uses Packet Detection rules for the basis of QoS. A problem for the packets from the AS 106 is that the packets need to find the correct QFI in order to apply the correct QoS profile for the DL carrier traffic flow 108, in order for the 5G-AN 102 to apply the correct QoS. QOS markings on the interface (e.g., N6 interface) and/or the DN 105 (e.g., Internet) cannot guarantee that the original QoS marking can be preserved. That is, the UPF 104 cannot guarantee that the received packets from AS 106 contain the correct QoS indication for packets of the DL carrier traffic 108 destined to the UE 101. Hence, it is not possible for the UE 101 to be in full control of the QoS for both UL carrier traffic 107 and DL carrier traffic 108.

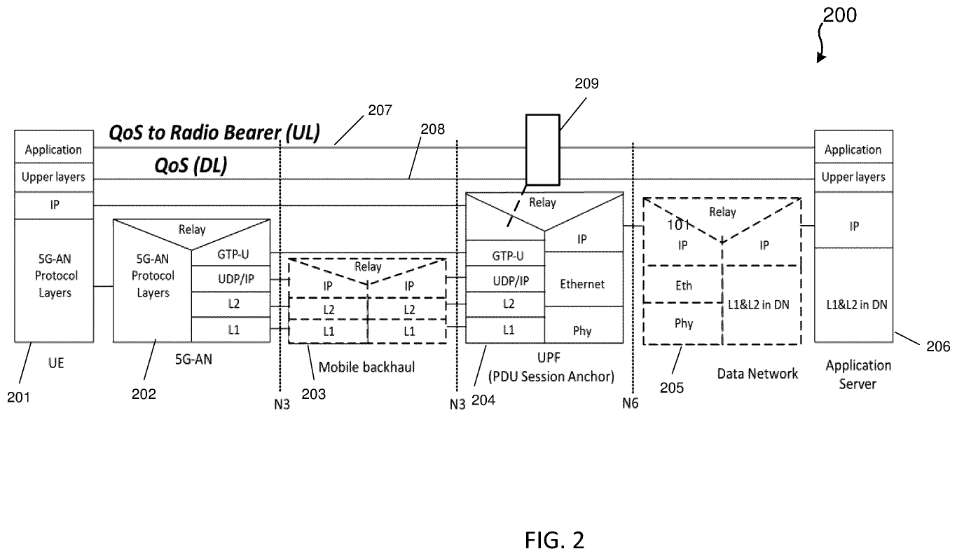

FIG. 2 shows a 5G communications system 200 in accordance with some embodiments of the present disclosure. The 5G communications system 200 is equivalent to system 100, but with an inclusion of a data structure 209 to capture a QoS parameter of the UL carrier traffic. Thus, UE 201, 5G-AN 202, Mobile Backhaul 203, UPF 204, DN 205 and AS 206 are equivalent in function with respective components 101-106 of FIG. 1 for some embodiments. The data structure 209 can be any of a variety of data storing structure. In some embodiments, the data structure 209 is a flow table used to capture selected information from a given traffic flow. The data structure 209 can reside with the UPF 204 or a firewall function associated with the 5G communications system. Generally, the data structure 209 is placed within a trusted environment in order to maintain integrity of the information stored therein.

When the UL carrier traffic 207 reaches the UPF 204, a QoS parameter (or marking) initiated for the UL carrier traffic is captured and stored in the data structure 209. Some associating information linking the UL carrier traffic and the DL carrier traffic is also retained within the data structure 209 linked to the QoS parameter. When packets return from the AS 206 in the DL, UPF 204 can use the associating information present in the DL carrier traffic 208 to locate the information, along with the stored QoS parameter linked to that associating information. The stored QoS parameter from the UL carrier traffic is retrieved and associated with the DL carrier traffic 208 to mark the DL carrier traffic 208 with the same QoS parameter as the UL carrier traffic 207. The 5G-AN 202 uses the QoS parameter in the DL to apply the QoS in the DL to the UE 201. By ensuring that the UL QoS and the DL QOS are the same, the UE has QoS control over the traffic flow in both directions.

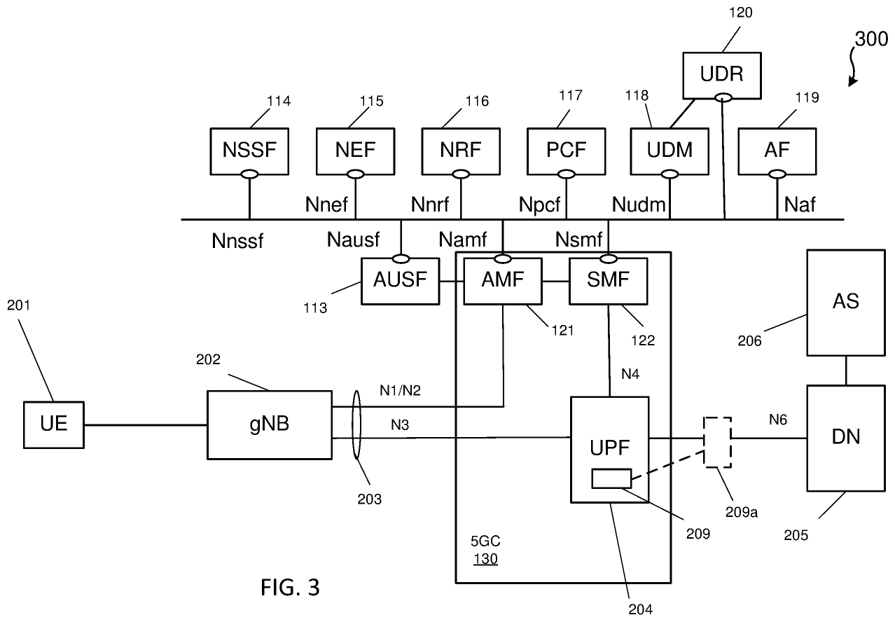

FIG. 3 shows a 5G communications system in accordance with some embodiments of the present disclosure. FIG. 3 shows a 5G communications system 300 as depicted in 3GPP Technical Specification (TS) 23.501 with a 5G Core (5GC) 130 and associated network functions 113-120. The 5G communications system 300 is a more detailed illustration of the 5G communication system 200 of FIG. 2. FIG. 3 also shows a wireless connection from the UE 201 to the 5G communications system via the 5G-AN 202, which is shown as a Radio Access Network (RAN). The RAN for the 5G system 300 can be the afore-mentioned New Radio (NR). The 5G RAN connection is shown as a gNodeB (gNB). Hence, 5G-AN 202 is also referred to as gNB 202 in the disclosure. The 5G communications system 300 also connects to the DN 205, such as the Internet. The gNB connects to the UPF 204 using interfaces N3 and the UPF 204 connects to the DN 205 using interface N6. The UPF 204 is a service function that processes user plane packets, which processing may include altering the packet's payload and/or header, providing interconnections, routing the packet, etc.

The base components of 5G Core (5GC) 130 are the UPF 204, an Access and Mobility Function (AMF) 121 and a Session Management Function (SMF) 122. Working with the 5GC components are various other network functions of the 5G communications system 300. The shown functional units are an Authentication Server Function (AUSF) 113 for storing data for authentication of a user device, a Network Slice Selection Function (NSSF) 114 for handling network slicing, a Network Exposure Function (NEF) 115 for exposing capabilities and events, a Network Repository Function (NRF) 116 for providing discovery and registration functionality for Network Functions (NFs), a Policy Control Function (PCF) 117, Unified Data Management (UDM) 118 for storing subscriber data and profiles, and an Application Function (AF) 119 for supporting specific applications and application influence on traffic routing. The 5G communications system 300 also includes a Unified Data Repository (UDR) 120, that connects to and operates with the UDM 118.

The base components of the 5GC 130 are the core network control plane functions configured to provide mobility management in the form of an Access and Mobility Function (AMF) 121 for providing UE based authentication, authorization, mobility management, etc.; a core network control plane function configured to provide session management in the form of a Session Management Function (SMF) 122 configured to perform session management, e.g. session establishment, modify and release; and the UPF 204. The configuration of various components/functions shown in FIG. 3 are examples only and other embodiments may have other configurations, including different set of components/functions.

Also shown affiliated with the UPF 204 is the data structure 209. As noted above, in some embodiments, the data structure 209 is a flow table. In some embodiments, the data structure 209 can reside as part of a firewall or a gateway (e.g., packet gateway), shown by dashed location 209a. As described above, when the UL carrier traffic reaches the UPF 204, a QoS parameter (or marking) initiated for the UL carrier traffic from the gNB 202 is captured and stored in the data structure 209. Some associating information linking the UL carrier traffic and the DL carrier traffic is also retained within the data structure 209 linked to the QoS parameter. When packets return from the AS 206 in the DL, UPF 204 (or firewall or gateway, if the data structure is implemented there) can use the associating information present in the DL carrier traffic to locate the information, along with the stored QoS parameter linked to that associating information. The stored QoS parameter from the UL carrier traffic is then associated with the DL carrier traffic, so that the same QoS marking can be applied to the DL carrier traffic.

Although different embodiments may employ different QoS parameters and data structures, in some embodiments DSCP is used for the QoS parameter. Differentiated Services (DiffServ) is a networking architecture mechanism for classifying and managing network traffic and providing QoS on IP networks. DiffServ uses a 6-bit DSCP in the 8-bit Differentiated Services (DS) field in the IP header for packet classification. DiffServ relies on a mechanism to classify and mark packets as belonging to a specific class. DiffServ-aware routers implement per-hop behaviors (PHBs), which define the packet-forwarding properties associated with a class of traffic. Different PHBs may be defined to offer, for example, low-loss or low-latency service. Rather than differentiating network traffic based on the requirements of an individual flow, DiffServ operates on the principle of traffic classification, placing each data packet into one of a limited number of traffic classes.

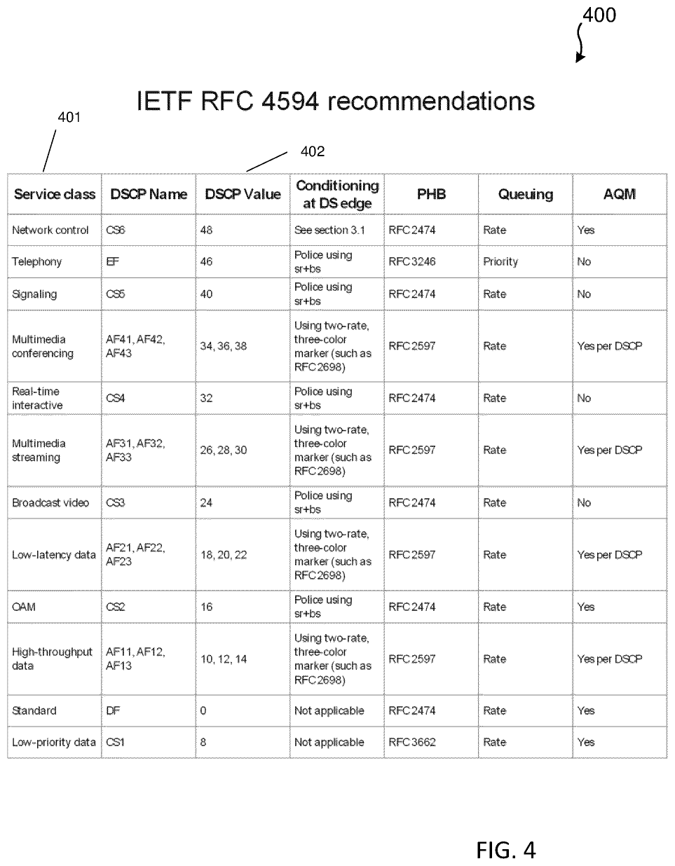

FIG. 4 shows a table 400 of DSCP values for use in accordance with some embodiments of the present disclosure. FIG. 4 shows a recommendation chart by the Internet Engineering Task Force (IETF) Request For Comments (RFC) document 4594 (RFC 4594) for DSCP, showing the service class 401 and DSCP values 402, along with other details. In implementing the DSCP for the QoS parameter described above, the scheme allows an application to use a DSCP value in the UL for carrier traffic, an entity in the network (e.g., UPF) to store the DSCP value, retrieve the DSCP value for DL, and mark the DSCP value in the DL carrier traffic. By doing this outside of the 3GPP QOS schemes, the filtering in 3GPP can map the traffic to the configured QoS class for that specific DSCP value.

This solution provides a scheme that allows the functionality of reusing existing 3GPP mechanisms for QoS, while at the same time allows the applications to indicate the desired behavior in accordance with the IETF standardized DSCP marking. Accordingly, the UE (or an application of the UE), when selecting the QoS for the UL carrier traffic can select the appropriate DSCP value based on the service class as identified in FIG. 4. The 5G-AN (gNB) 202 initiates the UL carrier traffic flow and passes the DSCP value to the UPF 204. The UPF 204 associates the DSCP value of the UL carrier traffic to some associating information linking the UL carrier traffic and the DL carrier traffic and stores the DSCP value linked to the associating information. In some embodiments, routing information is used for the associating information, since source and destination locations are present in both UL and DL flows.

The UPF 209 and surrounding equipment typically contain at least one flow table for caching information for different purposes. Typical locations of such functionality can be at: Deep Packet Inspection (DPI) in the UPF, load balancers in the UPF, Firewall/Network Address Translation (NAT) tables (in UPF or outside of the UPF). In some embodiments, the DSCP value is linked to routing information of a 5-tuple set, which includes a source Internet Protocol (IP) address, source port number, destination IP address, destination port number, and a type of protocol being employed. Thus, in some embodiments, routing information that includes source and destination locations (addresses/ports) provides the associating information linking the UL carrier traffic and the DL carrier traffic for a flow.

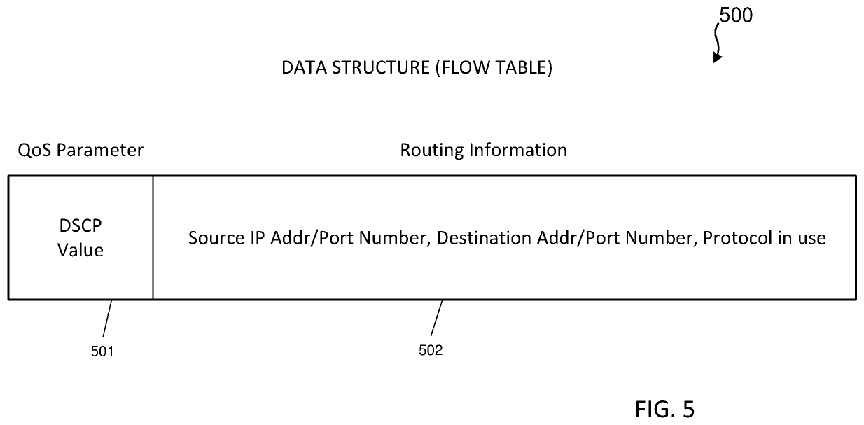

FIG. 5 shows an example data structure 500 linking the QoS parameter to the routing information in accordance with some embodiments of the present disclosure. The data structure 500 shown is used as part of the earlier described data structure 209. Thus, in some embodiments, data structure 500 is a flow table. An existing flow table or a new flow can be employed. Because a flow table(s) already exist in the UPF 204 that stores the 5-tuple set for the flow (associating the UL carrier traffic and the DL carrier traffic), in some embodiments, the DSCP value of the UL carrier traffic flow is linked to the respective flow. This linking of the DSCP value as a QoS parameter 501 and the 5-tuple set as routing information 502 is illustrated in FIG. 5.

When the DL carrier traffic arrives at the UPF 204, the 5-tuple set (e.g., routing information) for the DL traffic flow is the associating information in the flow table. By locating the respective 5-tuple entry 502 in the flow table, a corresponding DSCP entry is located. This DSCP value 501 is then used to identify the correct DL QOS, which is the same as the QoS for the UL carrier traffic. Thus, by linking the UL DSCP 501 value to the routing information 502 and storing the linked DSCP in the data structure 500 (e.g., flow table), the same QoS marking can be used (e.g., “reflected”) in the DL. This reflection of the DSCP from the UL to the DL can be done in a variety of ways, as long as the DSCP value written is allowed and handled properly in the UPF (e.g., provisioned into the DL QOS mapping following Traffic Flow Template (TFT) rules). Provisioning of such rules may be done via local configuration or from the PCF 117. The DL carrier traffic with the DSCP marking is sent to the AN 202 (e.g., gNB). Note that the data structure 500 shows only one entry, however, a flow table may store a plurality of DSCP-Routing Information entries for a plurality of flows.

Although FIG. 5 illustrates the use of the DSCP value for the QoS parameter and the 5-tuple set for the routing information, some embodiments can use other values and information. For example, in 5G, because carrier traffic flow includes QFI, the QFI can be used as the QoS parameter, wherein the UL QFI is stored in the data structure. Other QoS related parameters can be adapted for use as the described QoS parameter.

Likewise, instead of the 5-tuple set, some embodiments may use other information that includes unique identification of the traffic flow. Such unique identifier would need to be present in both the UL and DL carrier traffic flow for association of the UL and the DL to link to the stored QoS value in the data structure. The 5-tuple set was chosen, since the 5-tuple information is commonly present in current Internet Protocol (IP) data packets.

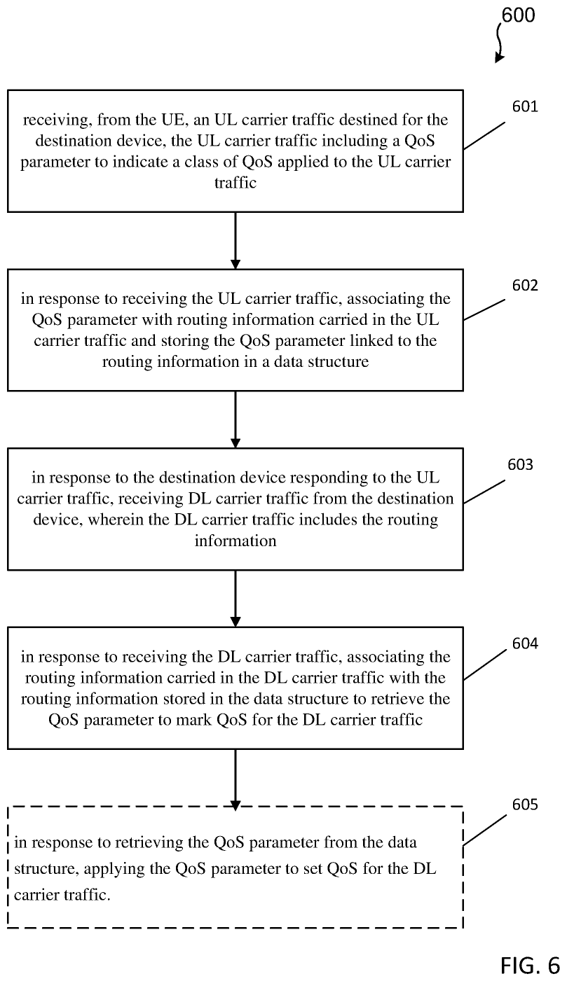

FIG. 6 shows a method for marking a QoS for packet traffic on a connection between a UE and a destination device in accordance with some embodiments of the present disclosure. A method 600 provides for marking a QoS for packet traffic on a connection between a UE and a destination device, where the node is disposed along the connection between the UE and the destination device. The method 600 performs steps 601-604 as noted below. The method is performed at a node, such as at UPF 204.

At step 601, the node receives, from the UE, an UL carrier traffic destined for the destination device, where the UL carrier traffic includes a QoS parameter to indicate a class of QOS applied to the UL carrier traffic. At step 602, in response to receiving the UL carrier traffic, the node associates the QOS parameter with routing information carried in the UL carrier traffic and stores the QOS parameter linked to the routing information in a data structure. At step 603, in response to the destination device responding to the UL carrier traffic, the node receives DL carrier traffic from the destination device, where the DL carrier traffic includes the routing information. At step 604, in response to receiving the DL carrier traffic, the node associates the routing information carried in the DL carrier traffic with the routing information stored in the data structure to retrieve the QoS parameter to mark QoS for the DL carrier traffic.

At an optional step 605, the node or another anode, such as a Radio Access Network (e.g., 5G-AN 202), performs, in response to retrieving the QoS parameter from the data structure, an operation of applying the QoS parameter to set QoS for the DL carrier traffic.

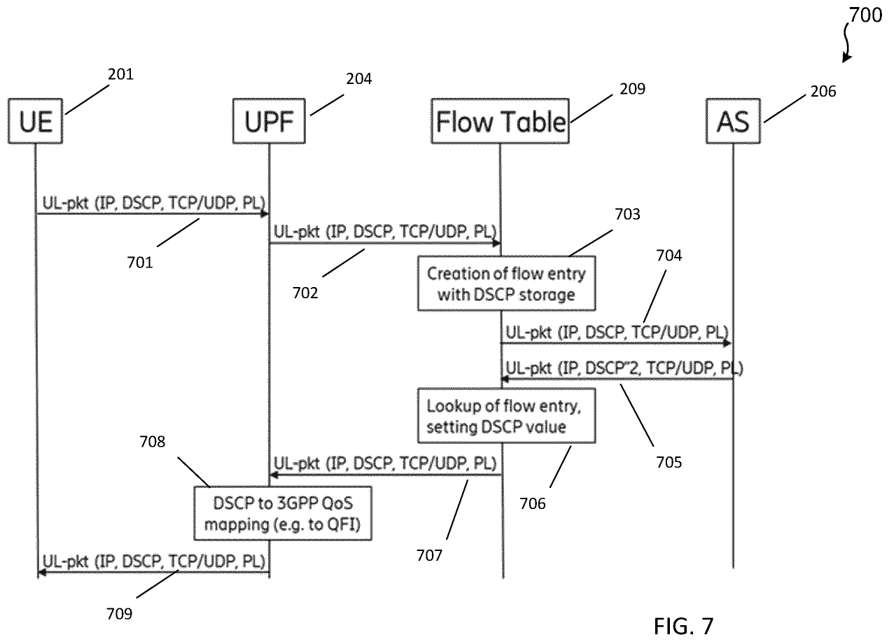

FIG. 7 shows a signalling diagram 700 in which the UL carrier traffic and the DL carrier traffic utilize the flow table to store the UL DSCP value in order to mark the DL carrier traffic with the same DSCP value in accordance with some embodiments of the present disclosure.

In diagram 700, at operation 701, the UE 201 sends an UL packet in a carrier traffic to UPF 204 via an access network (not shown in this diagram). The UL carrier traffic uses a protocol type that includes a DSCP value and routing information (e.g., IP address, etc.). At operation 702, the DSCP value and the routing information is sent to the data structure 209, shown as flow table 209. At operation 703, the flow table creates the flow entry with DSCP storage, where the DSCP is linked to the routing information. The flow table 209 is shown separate from the UPF 204 to illustrate that in some embodiments, the flow table may be present in the firewall or packet gateway. As described above, in some embodiments, the flow table 209 is part of or associated with the UPF 204. At operation 704, the UL carrier traffic arrives at the AS 206.

At operation 705, the AS 206 initiates the DL carrier traffic. The DL carrier traffic may include a QoS indicator, such as another DSCP value, along with the routing information. However, as earlier described above, the QoS indicator from the AS 206 may not relate to the same QoS as the QoS sent by the UE 201 in the UL. Whether there is a QoS indicator or not, at operation 706, the routing information in the DL carrier traffic allows for a lookup of flow entry to retrieve the DSCP value. The stored DSCP value is associated with the DL carrier traffic and sent to the UPF at operation 707. At operation 708, the UPF 204 uses the DSCP value as a QoS marker to apply the QOS mapping (e.g., QFI) to the DL carrier traffic. The DL carrier traffic is sent, via the access network, to the UE using the QoS which is the same QoS as the UL QOS at operation 709.

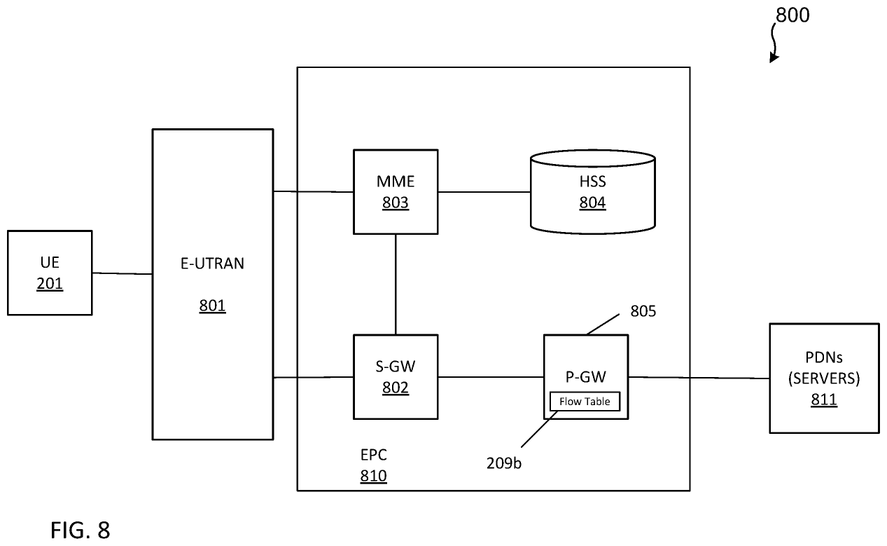

FIG. 8 shows a use of the flow table in a packet gateway of a 4G LTE communications system 800 in accordance with some embodiments of the present disclosure. The illustration of communication system 800 shows only those components that are pertinent for the understanding of the location of the flow table. The components shown are the Evolved UMTS (Universal Mobile Telecommunications Service) Terrestrial Radio Access network (E-UTRAN) 801, Mobility Management Entity (MME) 803, Home Subscriber Server (HSS) 804, Serving Gateway (S-GW) 802 and Packet Data Network (PDN) Gateway (P-GW) 805. Components 802-805 are part of the Evolved Packet Core (EPC) 810, which connects to the PDN servers 811. The PDN servers 811 are equivalent to AS 206.

Since LTE communication systems do not employ a UPF, the QoS parameter for the UL data traffic is captured and stored by flow table 209b of P-GW 805, along with the routing information. When the DL packet traffic arrives at the P-GW 209b, the routing information is used to retrieve the stored QoS parameter for marking the DL packet traffic. When the DL packet traffic arrives at the E-TRAN 801, the QoS parameter indicates the appropriate QoS for DL transmission to the UE 201.

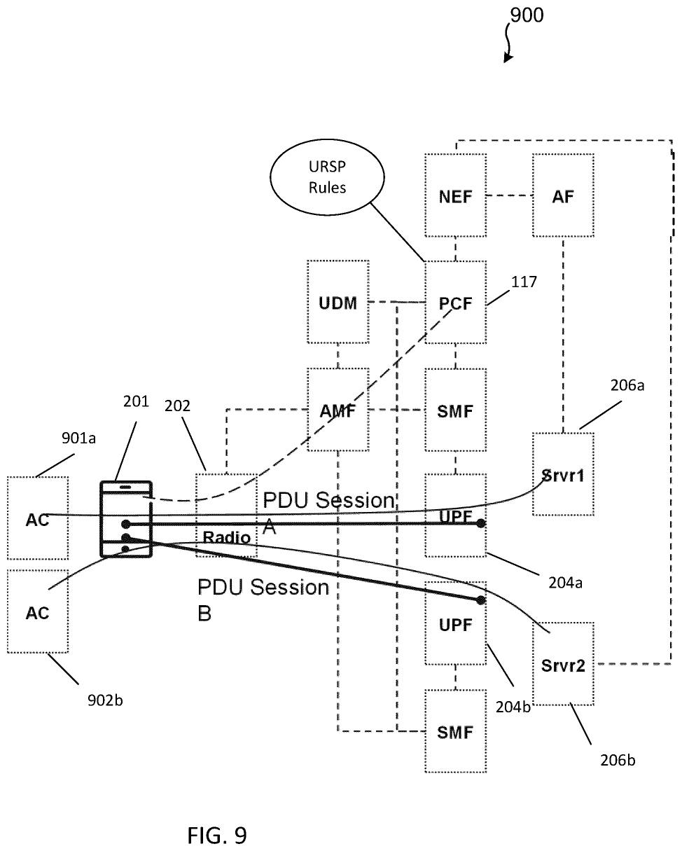

FIG. 9 illustrates an example of employing the disclosed technique where the connection between the UE and the destination device utilizes a network slice of a plurality of network slice connections in accordance with some embodiments of the present disclosure. System 900 is a 5G communication system in which the UE 201 establishes multiple connections to Application Servers 206a and 206b using respective different Application Clients (ACs) 901a and 901b. The 5G-AN 202 can handle different carrier traffic, shown as Protocol Data Unit (PDU) Session A and PDU session B, using network slices, where the QoS for each slice can be different. In this instance, the PDU sessions can operate via multiple UPFs, shown as UPF 204a and UPF 204b, controlled by a UE Route Selection Policy (URSP). Each of the carrier traffic connections can apply its UL carrier traffic QOS to the DL carrier traffic QoS by implementing one of the techniques described above.

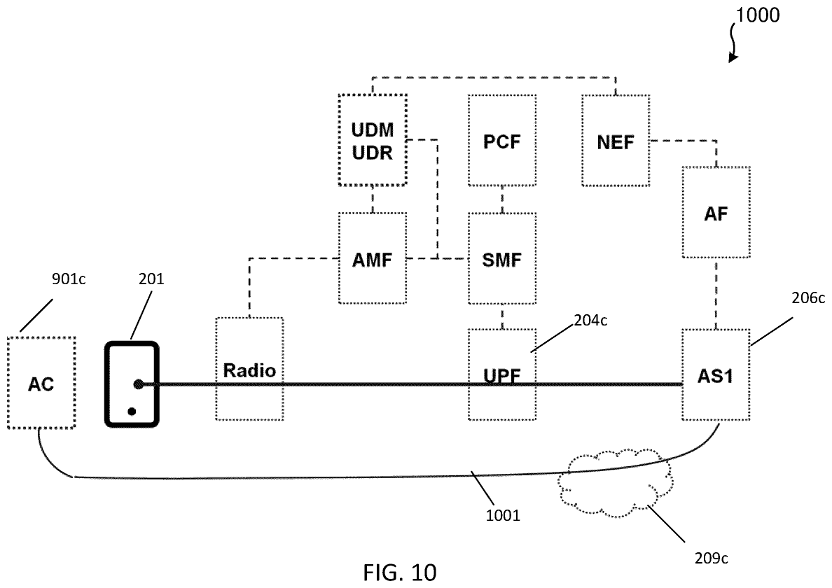

FIG. 10 illustrates an example of employing the disclosed technique where the connection that employs the data structure to store the QoS parameter is an Over the Top (OTT) connection in accordance with some embodiments of the present disclosure. System 1000 employs an OTT between an Application Client 901c operating on UE 201 and AS 206c. in this instance, instead of the UPF 204c storing the QoS parameter for DL traffic, the QoS parameter is stored external to the UPF 204c. The external storage 209c may be controlled by the operator of the OTT service, so that the QoS parameter provided to the OTT provider is retained and used by the OTT provider. Thus, the DL traffic on the OTT connection 1001 can use the same QoS in the OTT DL as the UE QOS in the UL.

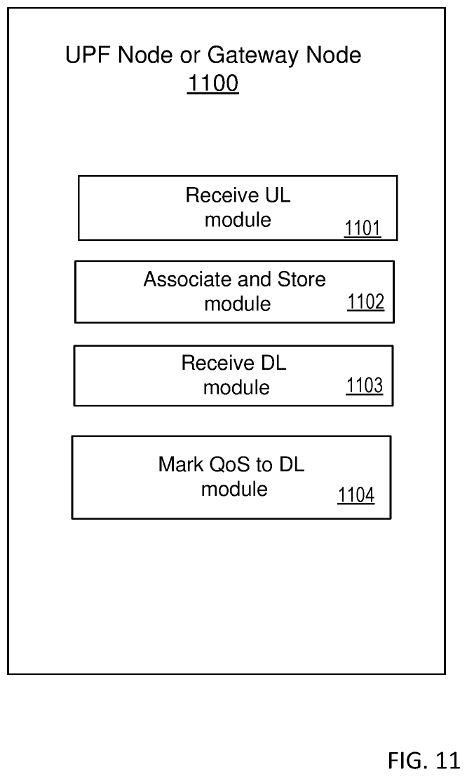

FIG. 11 shows an UPF node or Gateway node 1100 in accordance with some embodiments of the present disclosure. In some embodiments, the node 1100 can implement the functions of the method 600 of FIG. 6, as well as the various embodiments described in the disclosure. As shown, a Receive UL module 1101 can perform operations corresponding to the operations of step 601 of FIG. 6. An Associate and Store module 1102 can perform operations corresponding to the operations of step 602. A Receive DL module 1103 can perform operations corresponding to the operations of step 603. A Mark QoS to DL module 1104 can perform the operations corresponding to operation of step 604. The UPF or Gateway node 1100 may contain other functional elements that are not shown.

In some embodiments, the modules 1101-1104 can be provided as a computer program product, or software, that can include a machine-readable medium having stored thereon instructions, which can be used to program a computer system (or other electronic device) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In some embodiment, the modules of the node 1100 are implemented in software. In other embodiments, the modules of the node 1100 are implemented in hardware. In further embodiments, the modules of the node 1100 are implemented in a combination of hardware and software. In some embodiments, the computer program can be provided on a carrier, where the carrier is one of an electronic signal, optical signal, radio signal or computer storage medium.

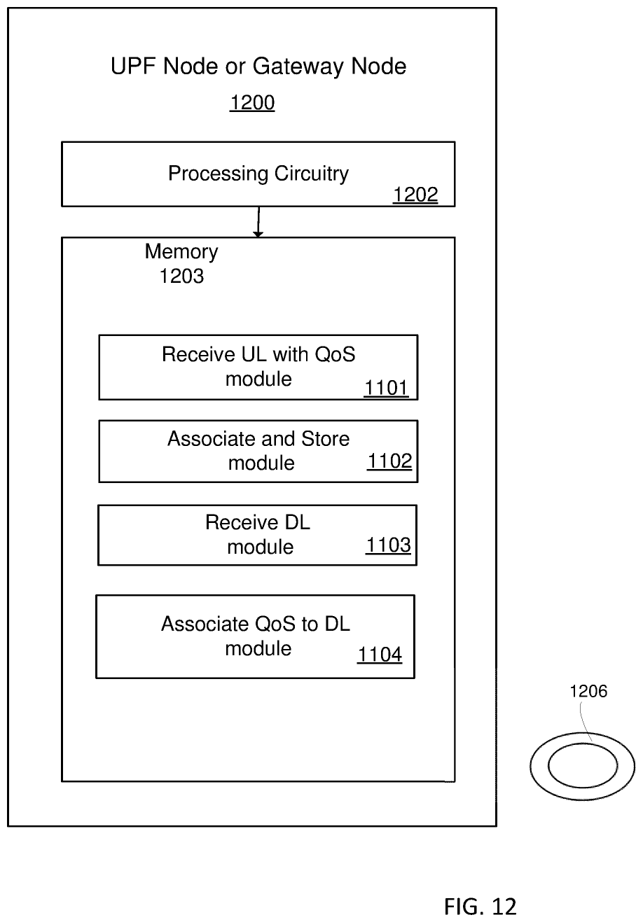

FIG. 12 shows an UPF node or Gateway node 1200 in accordance with some embodiments of the present disclosure. The node 1200 can implement the functions of the method 600 of FIG. 6, as well as the various embodiments described in the disclosure. In some embodiments, the node 1200 can be configured to implement the modules 1101-1104 of FIG. 11, wherein the instructions of the computer program for providing the functions of modules 1101-1104 reside in a memory 1203.

The UPF or Gateway node 1200 comprises processing circuitry (such as one or more processors) 1202 and a non-transitory machine-readable medium, such as the memory 1203. The processing circuitry 1202 provides the processing capability. The memory 1203 can store instructions which, when executed by the processing circuitry 1202, are capable of configuring the node 1200 to perform the methods described in the present disclosure. The memory can be a computer readable storage medium, such as, but not limited to, any type of disk 1206 including magnetic disks, optical disks, CD-ROMs, and magnetic-optical disks, read-only memories (ROMs), random access memories (RAMs), EPROMs, EEPROMs, magnetic or optical cards, or any type of media suitable for storing electronic instructions. Furthermore, a carrier containing the computer program instructions can also be one of an electronic signal, optical signal, radio signal or computer storage medium.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Furthermore, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

1. A method, at a node, for marking a Quality of Service (Qos) for packet traffic on a connection between a User Equipment (UE) and a destination device, wherein the node is disposed along the connection between the UE and the destination device, the method comprising:
receiving, from the UE, an Uplink (UL) carrier traffic destined for the destination device, the UL carrier traffic including a QoS parameter to indicate a class of QoS applied to the UL carrier traffic;
in response to receiving the UL carrier traffic, associating the QoS parameter with routing information carried in the UL carrier traffic and storing the QoS parameter linked to the routing information in a data structure;
in response to the destination device responding to the UL carrier traffic, receiving Downlink (DL) carrier traffic from the destination device, wherein the DL carrier traffic includes the routing information; and
in response to receiving the DL carrier traffic, associating the routing information carried in the DL carrier traffic with the routing information stored in the data structure to retrieve the QoS parameter to mark QoS for the DL carrier traffic.

2. The method according to claim 1 further comprising, in response to retrieving the QoS parameter from the data structure, applying the QoS parameter to set QoS for the DL carrier traffic.

3. The method according to claim 1, wherein the QoS parameter is Differentiated Services Code Point (DSCP).

4. The method according to claim 1, wherein the QoS parameter is QoS Flow Identifier (QFI).

5. The method according to claim 1, wherein the data structure is associated with a User Plane Function (UPF), of a 5^{th} Generation (5G) communications system.

6. The method according to claim 1, wherein the data structure is associated with a packet gateway of a communications system.

7. The method according to claim 1, wherein the data structure is a flow table.

8. The method according to claim 1, wherein the routing information comprises a 5-tuple set which includes a source Internet Protocol (IP) address, source port number, destination IP address, destination port number, and a type of protocol being employed, and wherein the QoS parameter is associated with the 5-tuple set and stored in the data structure linked to the 5-tuple set.

9. The method according to claim 1, wherein the connection between the UE and the destination device utilizes a network slice of a plurality of network slice connections between the UE and one or more destination devices.

10. A node for marking a Quality of Service (QoS) for packet traffic on a connection between a User Equipment (UE) and a destination device, wherein the node is disposed along the connection between the UE and the destination device, the node comprising:
one or more processors; and
a memory containing instructions which, when executed by the one or more processors, cause the node to:
receive, from the UE, an Uplink (UL) carrier traffic destined for the destination device, the UL carrier traffic including a QoS parameter to indicate a class of QoS applied to the UL carrier traffic;
associate the QoS parameter with routing information carried in the UL carrier traffic and store the QoS parameter linked to the routing information in a data structure;
receive (603) Downlink (DL) carrier traffic from the destination device, wherein the DL carrier traffic includes the routing information; and
associate the routing information carried in the DL carrier traffic with the routing information stored in the data structure to retrieve the QoS parameter to mark QoS for the DL carrier traffic.

11. The node according to claim 10 further comprising, in response to retrieval of the QoS parameter from the data structure, apply the QoS parameter to set QoS for the DL carrier traffic.

12. The node according to claim 10, wherein the QoS parameter is Differentiated Services Code Point (DSCP).

13. The node according to claim 10, wherein the QoS parameter is QoS Flow Identifier (QFI).

14. The node according to claim 10, wherein the data structure is associated with a User Plane Function (UPF) of a 5^{th} Generation (5G) communications system.

15. The node according to claim 10, wherein the data structure is associated with a packet gateway of a communications system.

16. The node according to claim 10, wherein the data structure is a flow table.

17. The node according to claim 10, wherein the routing information comprises a 5-tuple set which includes a source Internet Protocol (IP) address, source port number, destination IP address, destination port number, and a type of protocol being employed, and wherein the QoS parameter is associated with the 5-tuple set and stored in the data structure linked to the 5-tuple set.

18. The node according to claim 10, wherein the connection between the UE and the destination device utilizes a network slice of a plurality of network slice connections between the UE and one or more destination devices.

19. A non-transitory computer-readable storage medium comprising instructions which, when executed on at least one processor cause a node for marking a Quality of Service (QOS) for packet traffic on a connection between a User Equipment (UE) and a destination device, wherein the node is disposed along the connection between the UE and the destination device, to perform operations comprising:
receiving, from the UE, an Uplink (UL) carrier traffic destined for the destination device, the UL carrier traffic including a QoS parameter to indicate a class of QoS applied to the UL carrier traffic;
in response to receiving the UL carrier traffic, associating the QoS parameter with routing information carried in the UL carrier traffic and storing the QoS parameter linked to the routing information in a data structure;
in response to the destination device responding to the UL carrier traffic, receiving Downlink (DL) carrier traffic from the destination device, wherein the DL carrier traffic includes the routing information; and
in response to receiving the DL carrier traffic, associating the routing information carried in the DL carrier traffic with the routing information stored in the data structure to retrieve the QoS parameter to mark QoS for the DL carrier traffic.

20. (canceled)

21. The non-transitory computer-readable storage medium according to claim 19, wherein the instructions further to perform operations comprising, applying the QoS parameter to set QoS for the DL carrier traffic.
